(19) United States
(12) Patent Application Publication
(10) Pub. No.: US 2017/0217837 A1
(43) Pub. Date: Aug. 3, 2017

(54) FORMED FIRED REFRACTORY MATERIAL HAVING A HIGH LEVEL OF SPECTRAL EMISSION, METHOD FOR PRODUCTION THEREOF AND METHOD FOR INCREASING THE LEVEL OF SPECTRAL EMISSION OF REFRACTORY SHAPED BODIES

(71) Applicant: P-D REFRACTORIES GMBH, WILSDRUFF (DE)

(72) Inventor: FRED BRUNK, HATTINGEN (DE)

(73) Assignee: P-D REFRACTORIES GMBH, WILSDRUFF (DE)

(21) Appl. No.: 15/501,112

(22) PCT Filed: Jul. 29, 2015
(86) PCT No.: PCT/EP2015/067361

§ 371 Date: Feb. 1, 2017

(30) Foreign Application Priority Data
Aug. 1, 2014 (DE) 10 2014 215 214.3

(51) Int. Cl. C04B 35/14; C03B 5/43; C04B 35/64; C04B 35/632; C04B 35/638

(52) U.S. Cl. CPC C04B 35/14; C04B 35/632; C04B 35/638; C04B 35/64; C03B 5/43; C04B 2235/3418; C04B 2235/3826; C04B 2235/5427; C04B 2235/602; C04B 2235/656; C04B 2235/9607

(57) ABSTRACT

A process for producing a refractory material for use in the superstructure of glass melting tanks contains, as main components, SiO₂, SiC and a binder or binder mixture. A particulate substance, which in the spectral range from 1 μm to 5 μm and at temperatures above 1000° C. has a spectral emission capability which is higher than the spectral emission capability of the matrix of the refractory material, is incorporated into the matrix of the refractory material. A method of increasing the spectral emissivity of shaped, fired, refractory materials, is also provided.

Formed fired refractory material having a high level of spectral emission, method for production thereof and method for increasing the level of spectral emission of refractory shaped bodies

The invention relates to a fired, shaped refractory body, in particular for glass melting tanks. The invention further relates to a process for producing a shaped refractory body and a method of increasing the spectral emissivity of shaped refractory bodies.

Fuel-fired glass melting tanks are highly energy-consuming high-temperature process plants in which the raw materials required for glass production are melted from above using burners at temperatures of above 1450° C., in the case of soda-lime glasses up to 1550° C., to form a liquid glass melt. Heat transfer to the glass melt here occurs virtually exclusively by radiation, both directly from the burner flame or the combustion gases and also indirectly via the hot-side surface of the refractory lining above the surface of the glass melt in the superstructure (tank roof and side walls), which acts as secondary heating surface. Here, irradiation from opposite directions and multiple reflections between the roof and the walls inevitably also occurs. The wavelength- and temperature-dependent radiation properties of the main components of the furnace space participating in radiation exchange, i.e. the furnace atmosphere, the refractory material and the glass melt, are critical in determining the heat transfer. A description of glass melting furnaces may be found, for example, in the book “Glasschmelzöfen” by W. Trier (ISBN 3-540-12494-2).

Since refractory materials have selective radiation properties, the characteristic parameter for the radiation behavior thereof is the wavelength- and temperature-dependent emissivity, which has to be determined by measurement. For energy-related considerations, e.g. heat transfer calculations, the temperature-dependent total emissivity averaged over all wavelengths is required. The wavelength range from about 1 μm to 5 μm is critical here, because the largest proportion of the energy transferred by radiation occurs in this region at the temperatures prevailing in glass melting tanks owing to Wien's displacement law and Planck's radiation law. The spectral emissivities are dependent first and foremost on the chemical and mineralogical composition of the refractory material. The emissivity can assume values in the range from 0 to 1, with the latter representing a physical ideal state (known as black body).

Melting tanks for producing soda-lime glass, which represents by far the predominant proportion of total glass production, are lined with dense silica bricks in the tank superstructure, in particular in the tank roof. Owing to the excellent thermomechanical materials properties required for use in the roof at temperatures of from about 1500° C. to 1600° C., use is made exclusively of low-flux silica brick grades having an SiO₂ content of at least 93%, generally above 95%. A further, technically critical reason for use of these is the good dissolution behavior of silica brick constituents in contact with the glass melt. In the region of the walls which are subject to significantly less mechanical stress, use is also made of more corrosion-resistant alum ina-zirconia-silica bricks (cast AZS bricks) which, in addition to the main constituents Al₂O₃ and ZrO₂, have a low SiO₂ content of from about 12% to 16%. However, account has to be taken here of, inter alia, the risk of use-related sweating out of the glass phase from the brick material, which dissolves with difficulty in the glass melt and leads to streak formation or other glass defects. An overview of silica bricks and AZS materials is given, for example, in the book “Handbook of Refractory Materials”, edited by G. Routsohka and H. Wuthnow (ISBN 978-3-8027-3162-4).

For the production of highly thermally conductive silica bricks having a very low porosity, use of from 0.5 to 10% by weight of silicon nitride (Si₃N₄, also containing Si₂ON₂) or silicon carbide (SiC) or a mixture of the two having a particle size of less than 0.074 mm as mixed component and adherence to a very complicated temperature profile and quite specific furnace atmosphere during the firing process in the range from 1200° C. to 1400° C. are known from U.S. Pat. No. 4,183,761. This ensures that the necessarily very finely particulate nitride and/or carbide is converted completely into SiO₂ with an increase in volume during firing of the brick so as to fill the matrix pores and thus form a denser brick microstructure. The bricks produced according to this patent correspond to conventional silica bricks in terms of the chemomineralogical composition and the radiation properties. Silica bricks having high heat conduction are, however, extremely counterproductive for use in the glass tank, in particular in the roof, from the point of view of heat engineering, because the heat losses would increase as a result with otherwise the same structure of the roof insulation and an improvement in the radiation properties cannot be achieved using such bricks.

However, a great disadvantage in terms of heat transfer with the use of the refractory materials silica and AZS is that their total emissivity is known to decrease greatly with increasing temperature. It is obvious that an improvement in the radiation properties of the refractory lining in the superstructure will intensify the radiative heat transfer to the glass melt and energy savings and/or productivity increases can thus be achieved.

It has therefore already been proposed that the surface of the refractory material facing the firing space (hot-side surface during use) be coated, with the proviso that the coating has a higher emissivity than the refractory substrate. These coating materials (known as high-emission coatings) consist essentially of a pulverulent, refractory filler (or filler mixture), at least one binder and at least one pulverulent material having a high emissivity (high-emission material). The coating material is sprayed or painted with a paint-like consistency in a thin layer onto the refractory substrate before the glass melting tank goes into operation.

The patent U.S. Pat. No. 6,007,873 proposes, for example, a high-emission coating for a use temperature of above 1000° C., which consists of an aluminum phosphate-containing binder and a high-emission material addition of from 5% by weight to 75% by weight of rare earth oxides from the group consisting of cerium and terbium. Such coatings generally have a thickness of from 10 μm to 250 μm. In contrast to cerium oxide (CeO₂ and/or Ce₂O₃), the high-emission materials chromium oxide (Cr₂O₃) and silicon carbide (SiC) have failed due to reaction in a comparative evaluation at use temperatures of from 1400° C. to 1500° C. Information on the actual radiation behavior of the cerium oxide-containing coating and on the substrate has not been given, and effects achieved are indicated only indirectly as an improvement in the overall efficiency of a furnace.

U.S. Pat. no. 6,921,431 B2 discloses a thermal protective coating for, inter alia, refractory materials, which is, in particular, said to increase the emissivity of the coated substrate as well and, based on dry matter, has, inter alia, a proportion of from about 2% by weight to about 20% by weight of one or more high-emission materials such as silicon hexaboride (SiB₆), boron carbide (B₄C), silicon tetraboride (SiB₄), silicon carbide (SiC), molybdenum disilicide (MoSi₂), tungsten disilicide (WSi₂), zirconium diboride (ZrB₂), copper chromite (Cr₂Ce₂O₅) and metal oxides. The binder is colloidal silica and/or alumina and a preferably clay-mineral stabilizer addition of from about 1.5% by weight to about 5% by weight is said to increase the storage life of the ready-to-use coating solution (solids content from about 40% to about 70%). To avoid flaking, a maximum coating thickness in the dried state of from about 25.4 μm to 254 μm is recommended; from 150 g to 200 g of dry matter per m² of substrate surface are mentioned as optimal layer density. The coating is said to radiate back heat at use temperatures of up to 3500° F. (1926° C.). Verified data on the radiation behavior or at least confirmation of the functionality are, however, not given.

The refractory lining in the glass melting tank superstructure is more or less strongly corroded in production operation with tank operating lives of from about 8 to 14 years owing to the strong thermal and corrosive stresses, in particular due to reaction with the furnace gases loaded with mixed components and vaporization products, characterized, inter alia, by gradual removal of material. The removal of material can in the case of silica bricks in, for example, the roof have a total thickness of a number of centimeters. The useful life of a thin, very fine-grained and therefore not very corrosion-resistant coating is accordingly very limited. Unsatisfactory mechanical properties of the coating and/or poor adhesion to the substrate and/or a lack of oxidation resistance of the high-emission material used and also use-related reactions between the coating and the refractory substrate likewise have a highly adverse effect on the useful life. It should be noted in particular that even a small amount of coating material which gets into the glass melt leads to glass defects when the chemical composition of the coating differs greatly from that of the glass.

A further possible way of improving the radiative heat transfer in a glass melting tank is known from DE 28 14 250 C2, according to which an enlarged heat radiation area is achieved by means of surface profiling, in particular on the interior side, of the refractory bricks in the superstructure. For this purpose, the depressions are given a pyramid shape or the shape of a frustum of a cone, with the largest cross section thereof being directed toward the interior-side surface. A greater radiation area and in particular also the fact that the depressions are supposed to act like reflectors which bundle the radiated thermal energy are said to result in greater proportions of heat radiation being emitted from the superstructure into the furnace interior. However, in this embodiment, the by far predominant proportion of the surface of the refractory lining facing the furnace interior is still smooth and uniform, from which, according to the general teaching in respect of heat radiation transfer, only a small improvement in the total radiation capability can theoretically be derived. For the same reason, the efficiency of this type of surface profiling is still the subject of controversy in technical circles.

It is an object of the invention to create a refractory, shaped material for the superstructure of glass melting tanks, which has an improved heat radiation capability. A further object of the invention is to provide a process for producing the material and also to present a method by means of which the spectral emissivity of shaped refractory bodies can be increased.

These objects are achieved by claims 1, 4 and 11. Advantageous developments of the invention are specified in the respective dependent claims.

The invention is illustrated by way of example with the aid of a drawing. The radiation behavior of a shaped body (1) according to the invention is compared with that of commercial materials for the superstructure of glass melting tanks, a silica brick (2) and a cast AZS material (3). The figures show:

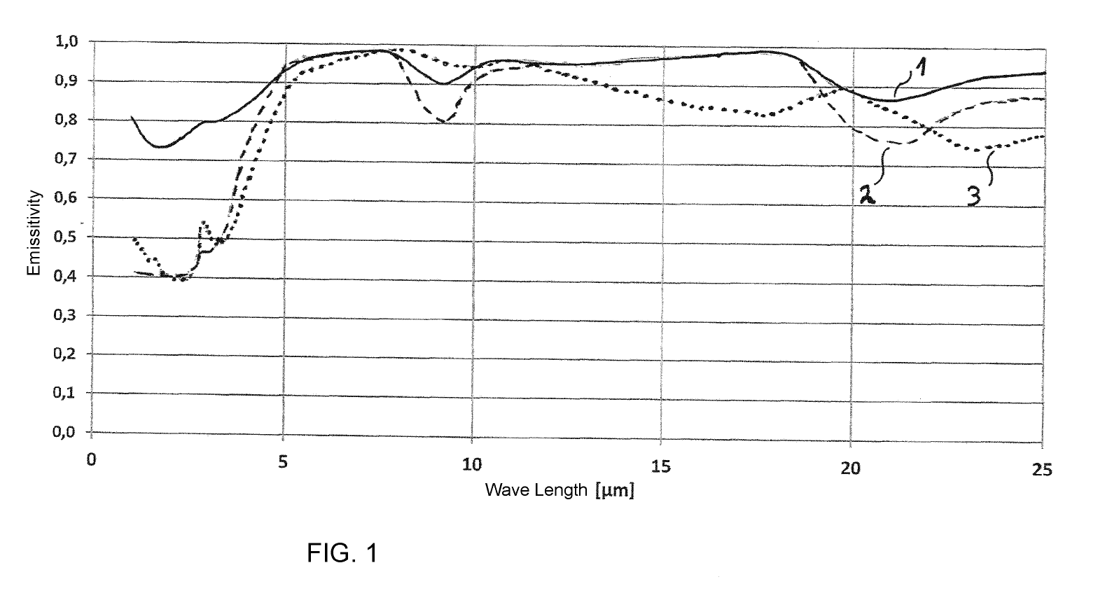

FIG. 1 the spectral emissivities (measurement temperature 1200° C.),

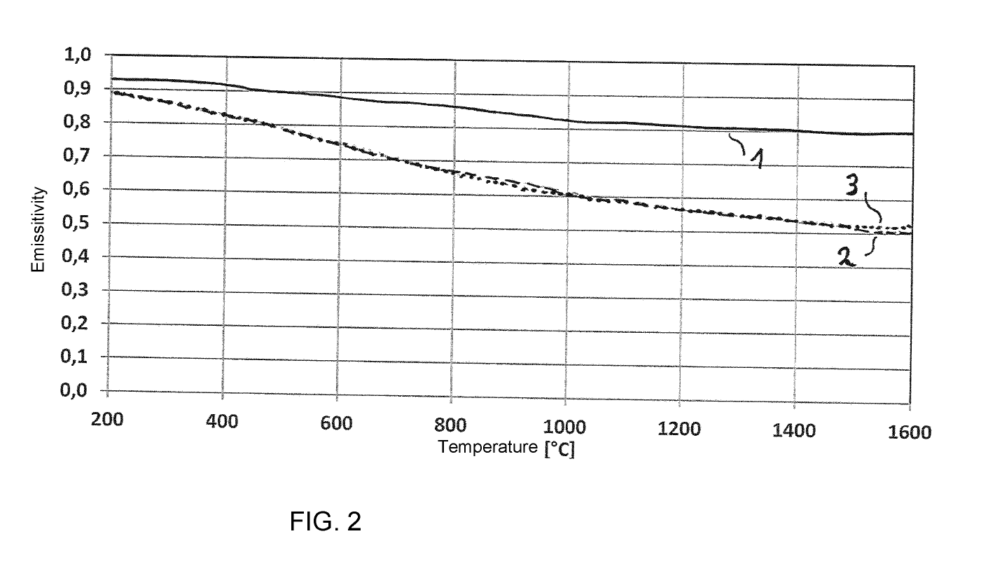

FIG. 2 the corresponding temperature-dependent total emissivities.

The measurement principle used here, as also in the working examples of this document, for determining the spectral emissivities is based on the comparison of the spectral radiative heat flow density of the sample material with that of the black radiator at the same temperature and under identical optogeometric conditions (known as static radiation comparison principle). The spectral emissivity measured at a particular temperature is used to calculate the total emissivity corresponding to this temperature and averaged over the wavelengths.

The invention is based on the surprising recognition that the heat radiation capability of a fired, shaped refractory body can be improved to a significant measurable extent when a substance having a high emissivity is present dispersed in the matrix of the shaped body, with the substance being compatible with the matrix. In contrast to a coating applied on one side, in the case of the material according to the invention the high-emission material is already a constituent of the microstructure of the material, resulting in the total shaped body having an improved radiation capability and a use-related removal of material due to prevailing corrosive stresses not leading to loss of the improved radiation capability, as in the case of a thinly coated material surface. Furthermore, the material of the invention can be lined with refractory bricks as are conventionally used in the tank superstructure.

The invention provides for the use of silicon carbide as high-temperature-resistant, nonoxidic high-emission material. Silicon carbide (SiC) is usually produced by a carbothermic reduction and carbonization of high-purity silica sand (SiO₂) by means of petroleum coke at from 2000° C. to 2400° C. by the Acheson process. A characteristic of SiC in high-temperature use at temperatures of up to about 1600° C. is the formation of a passivating layer of silicon dioxide as a result of reaction with atmospheric oxygen from the furnace atmosphere (known as passive oxidation). This process takes place as early as in the production of the material of the invention during a conventional firing. It has surprisingly been found that the protective SiO₂ layer formed around the remaining SiC core, i.e. the high-emission material, is significantly strengthened and protected against corrosion (compatibility) by a high SiO₂ content according to the invention in the matrix of at least 90% by weight, preferably at least 94% by weight. This also applies in particular to the surface or to the microstructure adjoining the surface of the shaped body, which ultimately determines the radiation behavior in later use. The use of SiC having a particle size of less than 1.5 mm, preferably less than 1 mm, has been found to be advantageous.

After the positive effect of SiO₂ was recognized in the context of the invention, an advantageous aspect of a particular embodiment of the invention is to use SiC particles which already have a protective SiO₂ layer, preferably by use of recycled material such as kiln furniture.

The high SiO₂ content in the matrix also results in, inter alia, the material of the invention gaining the thermomechanical properties required for high-temperature use, in particular the creep behavior under pressure. This is ensured by a conventional production firing, with the crystalline SiO₂ constituents tridymite and/or crystobalite being largely formed in the matrix from the SiO₂ raw materials used.

The raw materials basis for formation of the matrix of the material of the invention is amorphous SiO₂ or crystalline SiO₂ or a mixture of the two having a particle size of 0-6 mm, preferably 0-4 mm, as is customary for industrial refractory coarse ceramic materials. For example, transparent fused silica or cloudy fused silica or a mixture of the two is used as amorphous SiO₂; the SiO₂ contents of these are greater than 99% by weight. During firing of the bricks, conversion into crystobalite takes place above a temperature of about 1150° C. As crystalline raw materials, preference is given to using natural quartzites, silica sands and quartz flours consisting mineralogically of fl-quartz and having SiO₂ contents of greater than 96% by weight, either individually or as a mixture. At a high proportion of quartz-rich raw materials, commensurate addition of a mineralizer which, in an economical manner, promotes the required substantial conversion of the quartz into crystobalite and tridymite during firing of the shaped bodies and does not destroy the radiation properties of these by reaction with the high-emission material is necessary. Calcium hydroxide Ca(OH)₂, for example, meets these criteria and has been found to be particularly suitable because it additionally acts as binder.

According to the invention, the silicon carbide-containing high-emission material is mixed with at least one particulate SiO₂ raw material and with a suitable binder or binder mixture, optionally in combination with water, so as to form a pressable composition. As binders, it is possible to use, for example, lignosulfonates (waste sulfite liquor), dextrin, calcium hydroxide and phosphates. The raw materials comprising SiO₂ are assembled in such a way that at least 78% by weight of SiO₂ is present in the dry matter, taking into account the fact that the matrix of the subsequently shaped, dried and fired material comprises at least 90% by weight of SiO₂, preferably at least 94% by weight. The proportion of carbide-containing substance in the mixture is selected so that from 0.2% by weight to 20% by weight, preferably from 0.3% by weight to 15% by weight, based on the fired material, is present.

The prepared composition is, for example, shaped to give bricks and the bricks are dried. The bricks are subsequently fired under conditions generally customary for SiO₂-rich, refractory materials at sintering temperatures above 1200° C., preferably in the range from 1300° C. to 1550° C. The bricks treated in this way have formed a matrix which is advantageously predominantly crystalline, i.e. comprises crystobalite or tridymite or a mixture of the two, with the quartz content being very low, preferably less than 1% by weight.

The following working examples are provided for the purpose of illustration and are not intended to restrict the scope of protection of the invention.

Examples 1 to 3: the particulate raw material components X-ray-amorphous fused silica having a maximum particle size of 4 mm and a typical particle size distribution and various amounts of SiC having a particle size of 0-1 are together mixed homogeneously as 100% by weight with addition of an additional 1% by weight of waste sulfite liquor and 3.5% by weight of water. The proportions of SiC are 0% by weight (example 1), 5% by weight (example 2) and 15% by weight (example 3), with, in the case of addition of 0% by weight and 5% by weight, the proportion needed in each case to make up 15% by weight of SiC being replaced by silica having the appropriate particle size. The mixtures obtained in this way are pressed at a pressing pressure of about 80 MPa to give shaped bodies. After drying at 110° C. to constant weight, the compacts are fired at a sintering temperature of about 1450° C. The proportion of crystalline SiO₂ (crystobalite) determined by X-ray diffraction in the fired shaped bodies is greater than 50% by weight.

Examples 4 to 6: compared to examples 1 to 3, crystalline SiO₂ having a maximum particle size of 3 mm is used as SiO₂ raw material component and the proportions of SiC having a particle size of 0-1 mm are 0% by weight (example 4), 0.5% by weight (example 5) and 5% by weight (example 6). The proportion required in each case to make up 5% by weight of SiC is replaced by crystalline SiO₂ having the appropriate particle size. In addition, 0.5% by weight of waste sulfite liquor, 4% by weight of water and about 3% by weight of calcium hydroxide are added and mixed until the mixture is homogeneous. The shaped bodies pressed at a pressing pressure of about 80 MPa and subsequently dried to constant weight at 110° C. are fired at a sintering temperature of about 1450° C. The proportion of unconverted quartz in the fired shaped bodies is less than 1% by weight.

The critical properties determined are shown in the following table. As characterizing parameter for the radiation behavior, the total emissivity averaged over all wavelengths at 1600° C. is reported.

| | Example | Example | Example | Example | Example | Example |
|---|---|---|---|---|---|---|
| Feature | 1 | 2 | 3 | 4 | 5 | 6 |
| SiO₂ raw | amorphous | amorphous | amorphous | crystalline | crystalline | crystalline |
| materials basis | | | | | | |
| Bulk density | 1.83 | 1.87 | 1.89 | 1.83 | 1.84 | 1.83 |
| (g/cm³) | | | | | | |
| Open | 19.9 | 19.2 | 20.7 | 21.1 | 20.8 | 21.1 |
| porosity (%) | | | | | | |
| Cold | 22 | 24 | 23 | 47 | 45 | 49 |
| compressive | | | | | | |
| strength | | | | | | |
| (MPa) | 99.7 | 94.9 | 85.3 | 96.2 | 95.8 | 92.3 |
| SiO₂ content | | | | | | |
| (% by weight) | | | | | | |
| SiC content (*) | — | 4.77 | 14.30 | — | 0.38 | 3.81 |
| (% by weight) | | | | | | |
| Total emissivity | 0.51 | 0.72 | 0.80 | 0.50 | 0.62 | 0.72 |
| at 1600° C. | | | | | | |
| (o.d.) | | | | | | |
| Increase | — | +41% | +57% | — | +24% | +44% |

(*) in accordance with DIN EN ISO 21068-1/2

The radiation properties of the fired shaped bodies which are not according to the invention of examples 1 and 4 correspond to those of conventional silica bricks, with the shaped body of example 4 also being comparable in terms of the further properties to a conventional silica brick material for use in the superstructure of glass melting tanks. It can be readily seen from the examples that the radiation properties are measurably improved very effectively by the incorporation according to the invention of the high-emission material into the shaped body matrix. Even a very small amount of high-emission material in the matrix surprisingly brings about a drastic improvement, as can be seen from the comparison of the total emissivities at 1600° C. of examples 4 and 5.

All fired shaped bodies according to the invention (examples 2, 3, 5 and 6) display excellent creep behavior under pressure in accordance with EN 993-9 which corresponds to conventional silica bricks, characterized in that, at a test temperature of 1600° C. and a load of 0.2 MPa, the creep is less than 0.2% between hold times of 5 and 25 h.

A shaped body according to the invention produced as described in example 3 was subjected to a temperature of 1600° C. for 100 hours in an electrically heated furnace. The radiation properties subsequently measured correspond to those of the original shaped body. Furthermore, shaped bodies according to the invention produced as described in examples 2 and 6 were used under realistic conditions in the superstructure of a glass melting tank for soda-lime glass for somewhat more than one month. The subsequently measured radiation properties of the shaped body surface which had been exposed to the hot furnace atmosphere likewise correspond to those of the unused, original material.

It can readily be seen from the working examples that the invention provides, by simple means, an improvement which is unusual and was in no way foreseeable.

1-20. (canceled)

21. A process for producing a refractory material for use in the superstructure of glass melting tanks, the process comprising the following steps:
providing SiO₂, SiC and a binder or binder mixture as main components; and
incorporating into a matrix of the refractory material a particulate substance having a spectral emission capability being higher than a spectral emission capability of a matrix of the refractory material in a spectral range from 1 μm to 5 μm and at temperatures above 1000° C.

22. The process according to claim 21, which further comprises:
providing silicon carbide contained in the particulate substance;
mixing the particulate substance with at least one particulate SiO₂ raw material and a binder or binder mixture to form a pressable composition, shaped to give bricks; and
drying and subsequently firing the bricks.

23. The process according to claim 22, which further comprises:
mixing in SiC having a particle size of <1.5 mm as the substance containing silicon carbide;
providing a content of silicon carbide in the material to be from 0.2% by weight to 20% by weight; and
mixing in lignosulfonates, dextrin, calcium hydroxide, phosphates or substances having an equivalent effect with a proportion in the composition of not more than 6% by weight as a binder or binder mixture.

24. The process according to claim 23, wherein the SiC has a particle size of <1 mm, and the content of silicon carbide in the material is from 0.3% by weight to 15% by weight.

25. The process according to claim 22, which further comprises providing the substance containing silicon carbide with an SiO₂ layer.

26. The process according to claim 22, which further comprises providing recycled material or kiln furniture as the substance containing silicon carbide.

27. The process according to claim 22, which further comprises providing amorphous or crystalline SiO₂ or a mixture of amorphous and crystalline SiO₂ having an SiO₂ content of at least 96% by weight and a particle size of 0-6 mm in an amount of at least 78% by weight as the SiO₂ raw material.

28. The process according to claim 27, wherein the particle size is 0-4 mm.

29. The process according to claim 22, which further comprises firing the bricks at a temperature above 1200° C.

30. The process according to claim 22, which further comprises firing the bricks at a temperature in a range from 1300° C. to 1550° C.

31. A method of increasing the spectral emissivity of shaped, fired, refractory materials, the method comprising the following step:
embedding in a matrix of the refractory material a substance having a total emissivity being at least 15% higher than an emissivity of a matrix of the refractory material at a temperature range above 1000° C.

32. The method according to claim 31, wherein the refractory material is silica bricks for use in a superstructure and side walls of glass melting tanks.

33. The method according to claim 31, which further comprises providing the refractory material with a silicon dioxide content of at least 78% by weight and a particulate substance containing silicon carbide dispersed in a matrix of the refractory material, providing a quantity of silicon carbide in the material of from 0.2% by weight to 20% by weight and providing not more than 6% by weight of miscellaneous substances, with a total being 100% by weight.

34. The method according to claim 33, wherein the quantity of silicon carbide in the material is from 0.3% by weight to 15% by weight.

35. The method according to claim 33, wherein the matrix has an SiO₂ content of at least 90% by weight.

36. The method according to claim 33, wherein the matrix has an SiO₂ content of at least 94% by weight.

37. The method according to claim 33, which further comprises:
mixing the substance containing silicon carbide with at least one particulate SiO₂ raw material and a binder or binder mixture selected from the group consisting of lignosulfonates, dextrin, calcium hydroxide, phosphates and substances having an equivalent effect with an addition of water to form a pressable composition, shaped to give bricks; and
drying and subsequently firing the bricks at a temperature above 1200° C.

38. The method according to claim 37, which further comprises firing the bricks in a temperature range of from 1300° C. to 1550° C.

39. The method according to claim 33, which further comprises using SiC as the substance containing silicon carbide.

40. The method according to claim 33, which further comprises using SiC having an SiO₂ surface layer as the substance containing silicon carbide.

41. The method according to claim 33, which further comprises using a recycled material or kiln furniture as the substance containing silicon carbide.

42. The method according to claim 37, which further comprises mixing in amorphous or crystalline SiO₂ or a mixture of amorphous and crystalline SiO₂ in an amount of at least 78% by weight as the SiO₂ raw material.
